(19) United States
(12) Patent Application Publication
(10) Pub. No.: US 2024/0417217 A1
(43) Pub. Date: Dec. 19, 2024

(54) ELEVATOR CONTROL DEVICE

(71) Applicant: Mitsubishi Electric Corporation, Tokyo (JP)

(72) Inventors: Kazufumi HIRABAYASHI, Tokyo (JP); Takuya MIURA, Tokyo (JP)

(73) Assignee: Mitsubishi Electric Corporation, Tokyo (JP)

(21) Appl. No.: 18/698,370

(22) PCT Filed: Oct. 28, 2021
(86) PCT No.: PCT/JP2021/039726

§ 371 Date: Apr. 4, 2024

(51) Int. Cl. B66B 5/00; B66B 1/30; B66B 1/34; B66B 5/02; B66B 13/14; H02P 29/68

(52) U.S. Cl. CPC B66B 5/0025; B66B 1/30; B66B 1/3461; B66B 5/02; H02P 29/68; B66B 13/14

(57) ABSTRACT

An elevator control device is provided with a cooling fan, a component to be cooled that is used for drive control of a hoisting machine and is cooled by the cooling fan, a temperature sensor for measuring the temperature of the component to be cooled, and a control device for controlling the entire elevator apparatus. The control device includes a control unit and a cooling effect diagnosis unit. The control unit drives and controls the hoisting machine to perform a normal operation and an efficient heat generation operation in which the component to be cooled is heated to a temperature higher than the temperature during the normal operation for the diagnosis. The cooling effect diagnosis unit diagnoses the cooling effect of the component to be cooled on the basis of the temperature measurement value obtained from the temperature sensor during the efficient heat generation operation.

### TECHNICAL FIELD

The present disclosure relates to an elevator control device that performs cooling effect diagnosis.

### BACKGROUND ART

A conventional elevator control device for detecting abnormal conditions in an inverter device constituted with a main converter element, a cooling fan, and a cooling fin is equipped with temperature sensors that measure the temperatures of heat dissipation parts of the main converter element in the inverter device at multiple locations, and a data diagnosis unit that processes the temperature measurement data measured by the temperature sensors to detect an abnormality. The data diagnosis unit compares a past temperature rise value of the temperature measurement data measured by each temperature sensor with the latest temperature rise value, thereby detecting abnormal conditions of the inverter device by classifying the abnormal conditions for the main converter element, the cooling fan, and the cooling fin. In addition, when this classification is performed, an initial temperature rise value at the time of performing an abnormality diagnosis operation in which an operation is performed at a constant load is used (for example, refer to Patent Document 1).

### PRIOR ART DOCUMENT

### [Patent Document]

Patent Document 1: Japanese Unexamined Patent Application Publication No. 2020-45217

### SUMMARY OF INVENTION

### Problems to be Solved by Invention

When the temperatures are measured to detect abnormal conditions, the conventional elevator control device described above performs normal operation, not abnormality diagnosis operation. When the abnormal conditions are detected in the normal operation, the heat generation state of the inverter device is the same as that in the normal operation. Therefore, there is a problem in that an abnormality of the inverter device cannot be detected at an early stage when the abnormality of the inverter device is unlikely to appear as a change in the temperature measurement value, for example, when a part of a thermal interface material provided between the main converter element and the cooling fin is deteriorated, or when the abnormality of the main converter element of the inverter device is slight. In addition, when it is difficult to accurately measure the temperature, for example, in the case where the temperature sensor is away from the inverter device, there is a problem in that an abnormality of the inverter device cannot be detected at an early stage.

The present disclosure has been made in order to solve the above-described problems, and an object of the present disclosure is to provide an elevator control device that enables early detection of an abnormality of a component of the elevator control device.

### Means for Solving Problems

An elevator control device according to the present disclosure includes a cooling fan, a component to be cooled that is used for drive control of a hoisting machine and is cooled by the cooling fan, a temperature sensor to measure a temperature of the component to be cooled, a control unit to drive and control the hoisting machine and to perform a normal operation and an efficient heat generation operation of causing the component to be cooled to generate heat to a temperature higher than a temperature during the normal operation for diagnosis, and a cooling effect diagnosis unit to diagnose a cooling effect of the component to be cooled on a basis of a temperature measurement value obtained from the temperature sensor during the efficient heat generation operation.

### Advantageous Effect of Invention

According to the present disclosure, it is possible to obtain an elevator control device that enables early detection of an abnormality of a component of the elevator control device.

### BRIEF DESCRIPTION OF THE DRAWINGS

FIG. 1 is a block diagram showing an elevator apparatus including an elevator control device according to Embodiment 1.

FIG. 2 is a functional block diagram of a cooling effect diagnosis unit of the elevator control device according to Embodiment 1.

FIG. 3 is a flowchart showing operation control of a control unit in Embodiment 1.

FIG. 4 is a flowchart showing processes of the cooling effect diagnosis according to Embodiment 1.

FIG. 5 is a graph showing a relationship between a temperature rise amount and an operation time in the cooling effect diagnosis according to Embodiment 1.

FIG. 6 is a flowchart showing processes of abnormality occurrence time estimation in Embodiment 1.

FIG. 7 is a graph showing a relationship between a temperature rise reaching time and an end date and time of the cooling effect diagnosis in Embodiment 1.

FIG. 8 is a flowchart showing details of operation control in Embodiment 1.

FIG. 9 is a graph showing a relationship between the temperature rise reaching time and the end date and time of the cooling effect diagnosis when a plurality of temperature sensors are provided in the elevator control device according to Embodiment 1.

FIG. 10 is a flowchart showing cooling effect analysis processes according to Embodiment 2.

FIG. 11 is a graph showing a relationship between a temperature rise amount and an operation time in a cooling effect diagnosis according to Embodiment 2.

FIG. 12 is a graph showing a relationship between a temperature rise amount per unit time and an end time of the cooling effect diagnosis in Embodiment 2.

FIG. 13 is a graph showing a relationship between the temperature rise amount within time and the end time of the cooling effect diagnosis when a plurality of temperature sensors are provided in the elevator control device according to Embodiment 2.

### MODE FOR CARRYING OUT INVENTION

### Embodiment 1

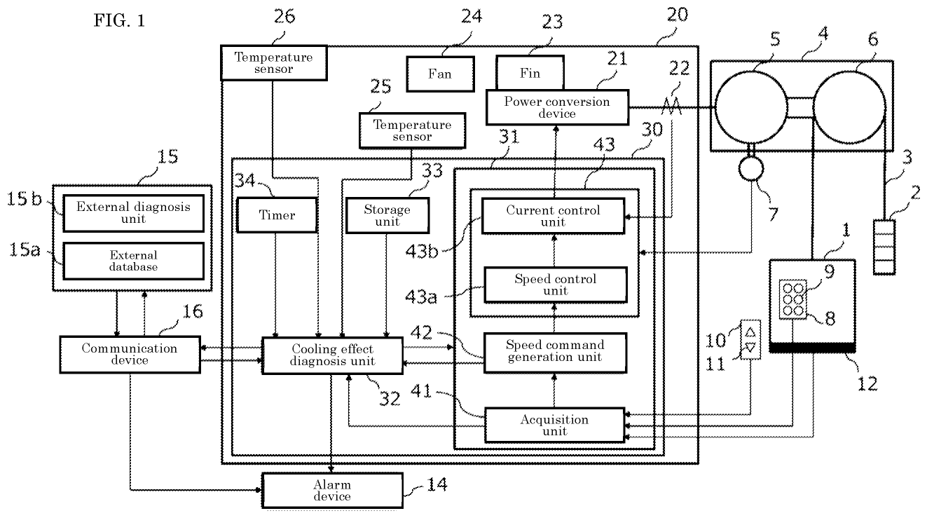

An elevator control device according to Embodiment 1 will be described. Note that the same reference numerals in the drawings denote the same or corresponding components. As shown in FIG. 1, an elevator apparatus includes a car 1, a counterweight 2, a main rope 3, a hoisting machine 4, and an elevator control device 20. The car 1 connected to one end of the main rope 3 and the counterweight 2 connected to the other end of the main rope 3 move in a hoistway (not shown) along a guide rail.

A hoisting machine 4 is provided in an upper portion of the hoistway. The hoisting machine 4 includes a motor 5 and a drive sheave 6. The main rope 3 is hung on the drive sheave 6 and driven by the motor 5. As the drive sheave 6 rotates, the car 1 moves. The motor 5 can be any type of motor, synchronous or asynchronous, it is, for example, a permanent magnet synchronous motor. The motor 5 is provided with a speed detector 7 for detecting the rotation speed of the drive sheave 6. The speed detector 7 is, for example, an encoder.

A car operation panel 8 is provided inside the car 1. The car operation panel 8 is provided with a plurality of destination floor registration buttons 9 for performing a destination floor registration operation. A hall operation panel 10 is provided at a hall of each floor. The hall operation panel 10 is provided with a plurality of call registration buttons 11 for performing an operation of call registration of the car 1. A weighing device 12 for measuring the load in the car 1 is provided in the lower part of the car 1.

The elevator control device 20 that performs speed control, operation management control, and the like for the car 1 will be described. The elevator control device 20 includes a power conversion device 21, a cooling fan 24, a first temperature sensor 25, a second temperature sensor 26, and a control device 30.

The power conversion device 21 is supplied with electric power from a commercial power supply via a circuit breaker (not shown), and supplies electric power to the motor 5 of the hoisting machine 4 in accordance with a voltage command output from the control device 30 to be described later. The power conversion device 21 is a component to be cooled by a cooling fin 23 and a cooling fan 24, which will be described later. An overcurrent that occurs when power is supplied to the power conversion device 21 is blocked by the circuit breaker. The current supplied to the motor 5 is detected as a motor current by a current detector 22. The power conversion device 21 is an inverter that variably controls an amplitude, phase, and frequency of an output voltage by pulse width modulation (PWM) control. In this inverter, a plurality of pulse trains of DC voltages is generated within a cycle of an AC voltage, and an average voltage of the pulse width is modulated into a sine wave shape to be an output voltage. Therefore, the output voltage of the power conversion device 21 is controlled in accordance with the voltage command, and the control is performed by adjusting the duty ratio obtained by multiplying the pulse width by the frequency.

The power conversion device 21 is provided with the cooling fin 23 for cooling the power conversion device 21. The cooling fin 23 has, for example, a plurality of plate members arranged in parallel in a part of its shape in order to enhance the heat dissipation effect of the power conversion device 21.

The cooling fan 24 dissipates heat of the elevator control device 20 to cool the elevator control device 20 and components of the elevator control device 20. The first temperature sensor 25 measures a heat radiation temperature of a component to be cooled in the elevator control device 20 cooled by the cooling fan 24. The second temperature sensor 26 measures the temperature within the elevator control device 20. The second temperature sensor 26 is preferably installed in a place where temperature variation is small, and in a place less likely to be affected by heat generated by components in the elevator control device 20. Note that the second temperature sensor 26 may measure the temperature of a machine room (not shown) outside the elevator control device 20. In this case as well, it is preferable to install it in a place where it is not easily affected by the heat generation of components in the machine room and the temperature variation is small.

In the present embodiment, a case where the component to be cooled is the power conversion device 21 will be described as an example. However, the component to be cooled may be any component as long as it is used for drive control of the hoisting machine 4 and is cooled by the cooling fan 24.

The control device 30 is a device such as a control board constituted with a processor, a memory, and an input/output interface that include a semiconductor integrated circuit, and controls the entire elevator apparatus. The control device 30 includes a control unit 31, a cooling effect diagnosis unit 32, a storage unit 33, and a timer 34.

A control unit 31 drives and controls the hoisting machine 4, and performs a normal operation, an efficient heat generation operation for causing a component to be cooled to generate heat to a temperature higher than a temperature during the normal operation for diagnosis, and a suppression operation for suppressing heat generation of the component to be cooled to a temperature lower than the temperature during the normal operation by reducing a heat generation amount of the component to be cooled when determining that abnormality occurs. The temperature higher than the temperature at the time of the normal operation is a temperature higher than a temperature reached when the normal operation is performed in a predetermined elapsed time from the start of the operation.

The control unit 31 includes an acquisition unit 41, a speed command generation unit 42, and a movement control unit 43.

The acquisition unit 41 includes a software module that acquires destination floor registration information, call registration information, and the load in the car 1 and holds them as operation management information. The destination floor registration information is acquired from the car operation panel 8, the call registration information is acquired from the hall operation panel 10, and the load in the car 1 is acquired from the weighing device 12.

The speed command generation unit 42 includes a software module that generates a speed command for controlling the speed of the car 1 on the basis of the operation management information held by the acquisition unit 41. Further, the speed command generation unit 42 is provided with a software module that holds a moving time of the car 1 from a moving speed and a moving distance of the car 1 determined by the speed command.

The movement control unit 43 includes a speed control unit 43a and a current control unit 43b. The speed control unit 43a includes a software module that calculates a speed deviation based on the speed command generated by the speed command generation unit 42 and a rotation speed of the motor 5 detected by the speed detector 7. Further, the speed control unit 43a includes a software module that calculates, on the basis of the calculated speed deviation, a target value of a q-axis current in the current vector control terms required for the rotation speed of the drive sheave 6 to follow the speed command.

The current control unit 43b includes a software module that creates a voltage command for controlling the current and voltage that are supplied to the motor 5 of the hoisting machine 4 by the power conversion device 21 on the basis of the target value of the q-axis current calculated by the speed control unit 43a, the measurement value of the motor current obtained from the current detector 22, and the rotation speed of the motor 5 detected by the speed detector 7, and outputs the voltage command to the power conversion device 21. Since the voltage output from the power conversion device 21 to the motor 5 is controlled by the duty ratio, the voltage command includes information on the duty ratio.

The storage unit 33 is a storage device constituted with a volatile or nonvolatile memory. The storage unit 33 stores an operation pattern for controlling the efficient heat generation operation to be described later and an operation pattern for controlling the suppression operation in the elevator apparatus, which will be described below.

The timer 34 is a control device that outputs an output signal at a predetermined time after an input signal is input, and it holds date and time information.

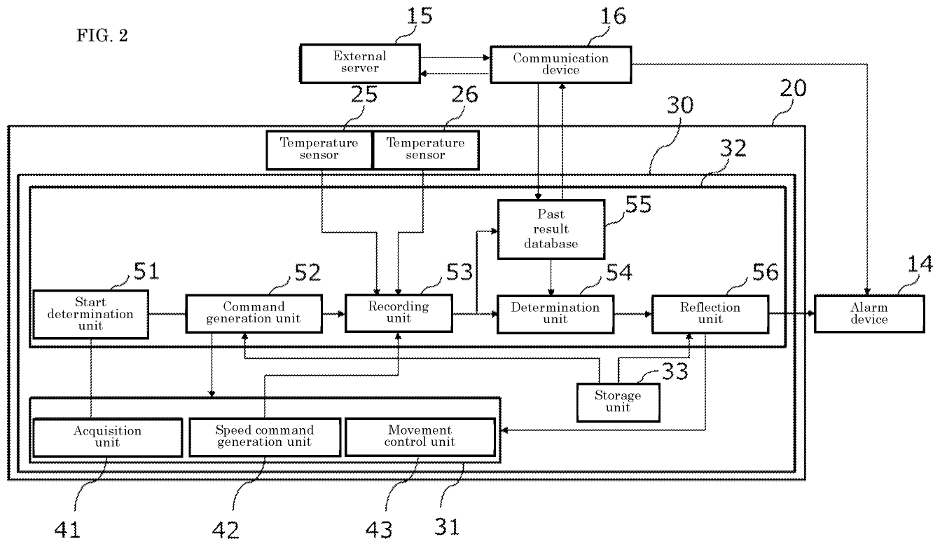

The cooling effect diagnosis unit 32 is a group of software modules that diagnose the cooling effect of a component to be cooled on the basis of the temperature measurement values obtained from the first temperature sensor 25 during the efficient heat generation operation. As shown in FIG. 2, the cooling effect diagnosis unit 32 includes a start determination unit 51, a command generation unit 52, a recording unit 53, a determination unit 54, a past result database 55, and a reflection unit 56, and performs the cooling effect diagnosis of the power conversion device 21 cooled by the cooling fan 24 of the elevator control device 20. The cooling effect diagnosis unit 32 may diagnose the cooling effect of a component to be cooled on the basis of the temperature measurement values obtained from the first temperature sensor 25 and the second temperature sensor 26 during the efficient heat generation operation.

The start determination unit 51 includes a software module that determines whether or not to start the cooling effect diagnosis on the basis of the operation management information acquired by the acquisition unit 41.

In order to perform the cooling effect diagnosis, the command generation unit 52 includes a software module that reads out an operation pattern of the efficient heat generation operation stored in the storage unit 33 and outputs an efficient heat generation operation control command to the control unit 31. In addition, the command generation unit 52 includes a software module that determines whether an execution of the operation pattern of the efficient heat generation operation is ended.

The recording unit 53 includes a software module that records a time with respect to the temperature rise of the temperature measurement value obtained from the first temperature sensor 25 during the efficient heat generation operation, that is, a temperature rise reaching time. In addition, the recording unit 53 includes a software module that calculates a cooling effect diagnosis operation time and an end date and time of the cooling effect diagnosis on the basis of the moving time of the car 1 held by the speed command generation unit 42. Note that the recording unit 53 may record the temperature rise reaching time on the basis of the temperature measurement values obtained from the first temperature sensor 25 and the second temperature sensor 26 during the efficient heat generation operation.

The past result database 55 is a storage means that accumulates the temperature rise reaching time recorded by the recording unit 53 and the end date and time of the cooling effect diagnosis in association with each other and holds them as past data. For example, the temperature rise reaching time and the end date and time of the cooling effect diagnosis for 20 years are accumulated in association with each other and stored as past data.

The determination unit 54 includes a software module that determines that an abnormality has occurred in the cooling effect when the temperature rise reaching time is out of a normal range. In addition, the determination unit 54 includes a software module that determines that an emergency response is required when the rate of change exceeds a predetermined range on the basis of the temperature rise reaching time. Further, the determination unit 54 includes a software module that estimates a time when an abnormality is to occur in the cooling effect on the basis of past temperature measurement values during the efficient heat generation operation.

The reflection unit 56 includes a software module that outputs a signal and diagnosis data to an alarm device 14 on the basis of the determination of the determination unit 54. The diagnosis data is data output as a result of diagnosis of an abnormality occurrence time or the like estimated by the determination unit 54. The diagnosis data is not limited to the abnormality occurrence time, and may include the temperature rise reaching time recorded by the recording unit 53 and the past data held by the past result database 55. Further, the reflection unit 56 includes a software module that reads out an operation pattern of the suppression operation for suppressing the heat generation of the power conversion device 21 more than the normal operation when the determination unit 54 determines the warning state, and outputs a suppression operation control command. Since the contents of the cooling effect diagnosis unit 32 have been described above, a description of the entire elevator apparatus will be continued by referring back to FIG. 1.

The alarm device 14 is a device for informing a maintenance staff or the like of the elevator apparatus. For example, it is an information terminal of a management company that manages the elevator apparatus, an information center of the elevator apparatus maintenance company, or a portable information terminal held by a maintenance staff who performs maintenance of the elevator apparatus.

An external server 15 is a computer connected to an elevator apparatus via a communication device 16. The external server 15 includes an external database 15a and an external diagnosis unit 15b. The external database 15a is a storage device constituted with a volatile or nonvolatile memory. The elevator apparatus transmits basic specification information, operation information, and diagnosis data of the elevator apparatus to the external database 15a. Basic specification information includes a rated speed, a loading capacity, and a lifting stroke of the car 1, or at least one or two pieces of information thereof. The operation information includes the number of times of activation of the elevator, a travel distance of the car 1, the total travel time of the car 1, or at least one or two of these pieces of information. The diagnosis data includes the abnormality occurrence time estimated by the determination unit 54, the temperature rise reaching time recorded by the recording unit 53, and the past data held by the past result database 55, or at least one or two pieces of information thereof.

The external diagnosis unit 15b is provided with a software module for selecting a plurality of similar elevator apparatuses on the basis of the basic specification information and the operation information of each elevator apparatus held by the external database 15a. Further, the external diagnosis unit 15b is provided with a software module for diagnosing the cooling effect of the power conversion device 21 cooled by the cooling fan 24 by comparing with diagnosis data of a similar elevator apparatus. The similar elevator apparatus is an elevator apparatus having similar basic specification information or operation information.

Next, regarding the operation of the present embodiment, a case of diagnosing the cooling effect of the power conversion device 21 will be described.

### Operation Control

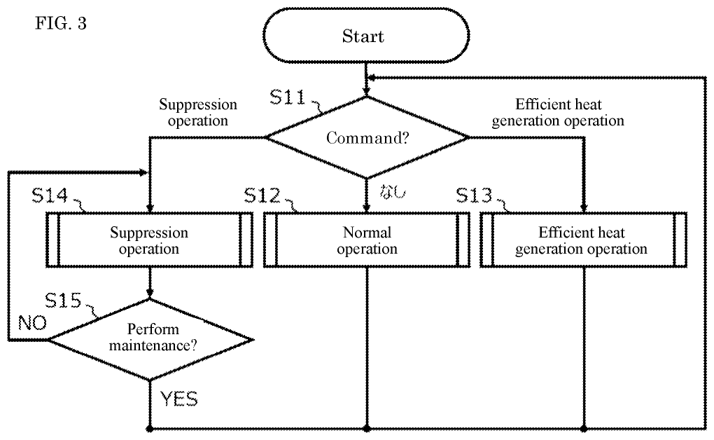

First, operation control of the elevator apparatus in this embodiment will be described with reference to FIG. 3. FIG. 3 is a flowchart showing the operation control of the elevator apparatus by the control unit 31. The operation control includes three different control operations: the normal operation, the efficient heat generation operation, and the suppression operation. The normal operation is an operation for carrying passengers or cargo and is normal operation control of the car 1 based on a destination floor registration by the car operation panel 8 and the call registration by the hall operation panel 10. The efficient heat generation operation is an operation by the operation control performed when the cooling effect is diagnosed. The suppression operation is an operation by the operation control for controlling the car 1 so as to reduce a thermal load on a component to be cooled with an output suppressed as compared with the normal operation when it is determined that there is an abnormality as a result of the diagnosis.

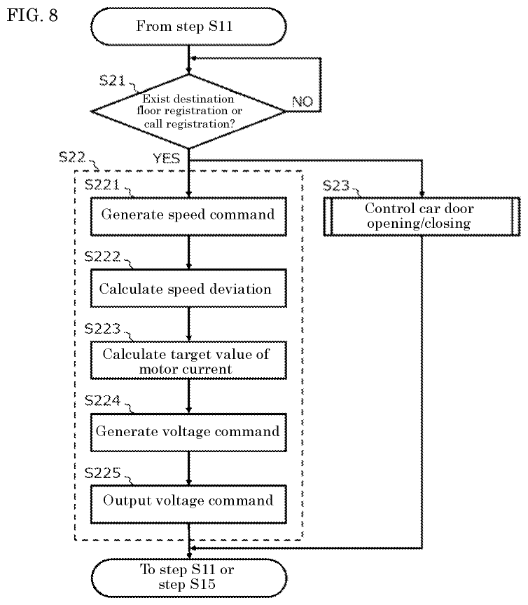

In step S11, the control unit 31 determines the presence or absence of the efficient heat generation operation control command or the suppression operation control command from the cooling effect diagnosis unit 32. Each command may be performed by transmission and reception of a command signal or may be performed by a control flow of a computer such as calling of a software module. For example, the control command includes information for identifying whether the operation is the efficient heat generation operation or the suppression operation, and the control unit 31 determines which operation is to be executed in accordance with the identification information. The control command may include not only the identification information but also control parameters such as a speed, destination floor information, and a target value of a motor current. When the control command is present, the control unit 31 controls the elevator apparatus by the efficient heat generation operation (step S13) or the suppression operation (step S14) in accordance with the control command. If no command is present, the elevator apparatus is controlled in the normal operation (step S12). The suppression operation of step S14 is repeated as long as maintenance is not performed in step S15. In this way, the control unit 31 of the present embodiment cooperates with the cooling effect diagnosis unit 32 to perform the efficient heat generation operation and can perform an operation with a larger amount of heat generation than the normal operation. Therefore, the cooling effect diagnosis unit 32 can detect the abnormality of the cooling effect earlier. Details of each operation will be described later with reference to FIG. 8.

### Cooling Effect Diagnosis

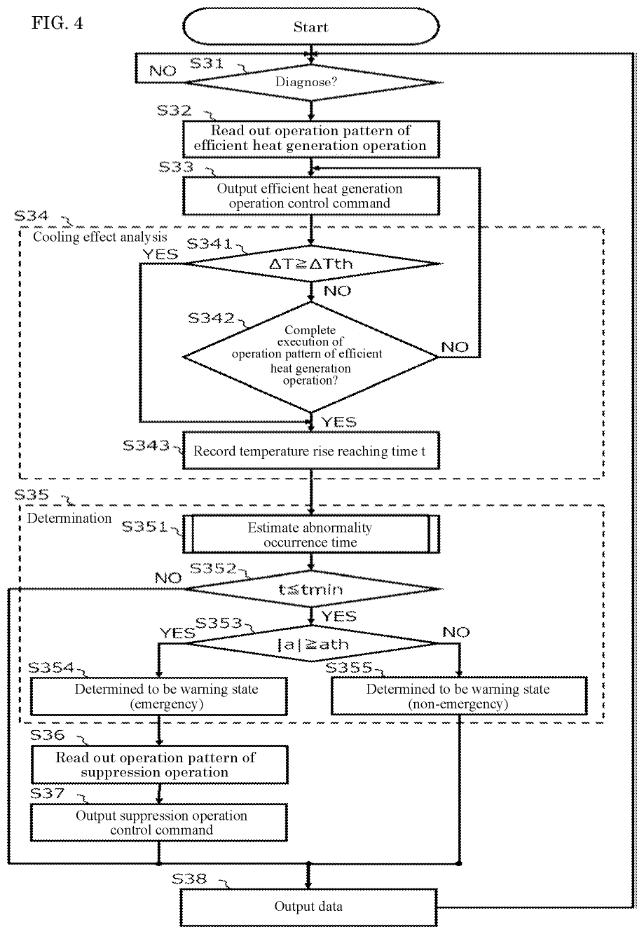

The cooling effect diagnosis by the cooling effect diagnosis unit 32 will be described with reference to FIG. 4.

In step S31, the start determination unit 51 determines whether or not to start the cooling effect diagnosis. A main function of the start determination unit 51 is to find a timing at which the cooling effect diagnosis is performed when the elevator is not frequently used (for example, at midnight). For this purpose, stop time information of the elevator from the control unit 31 (for example, checking of long-term stop timing) and load information in the car 1 from the weighing device 12 are used to check whether or not there is no loading in the car 1. Then, it is determined whether or not to start the cooling effect diagnosis on the basis of the destination floor registration or the call registration in the operation management information held by the acquisition unit 41. For example, the start determination unit 51 acquires the destination floor registration or the call registration in the operation management information of the acquisition unit 41, determines whether the destination floor registration button 9 or the call registration button 11 has not been pressed for a predetermined time or more, that is, whether the elevator apparatus is in a resting state, and determines to start the cooling effect diagnosis if the elevator apparatus is in the resting state. At this time, it is more preferable that the start determination unit 51 further acquires the temperature measurement value of the power conversion device 21 from the first temperature sensor 25 and determines whether the temperature change within the predetermined time falls within the predetermined range. If it is not in the resting state, step S31 is repeated. If it is determined to start the cooling effect diagnosis, the process proceeds to step S32.

In step S32, the command generation unit 52 reads out an operation pattern for controlling the efficient heat generation operation of the elevator apparatus from the storage unit 33. The efficient heat generation operation is an operation of causing the power conversion device 21, which is the component to be cooled, to generate heat to a temperature higher than the temperature during the normal operation for diagnosis. In order to make the power conversion device 21 generate heat more than in the normal operation, it is necessary to increase the amount of current per unit time supplied to the power conversion element of the power conversion device 21. For this reason, a method of operating the power conversion device 21 at a high frequency or a method of causing a reactive current not contributing to torque generation of the motor 5 to flow in the power conversion device 21 is effective. As specific operation patterns of the efficient heat generation operation, three examples will be described below.

The first is a first operation pattern for driving and controlling the hoisting machine 4 in such a way that the absolute value of the acceleration of the car 1 is larger than that in the normal operation. The second is a second operation pattern in which the doors of the car 1 are controlled to be closed, and the hoisting machine 4 is controlled to be driven continuously or intermittently in such a way that the travel distance of the car 1 per unit time is longer than that in the normal operation. The third is a third operation pattern in which the power conversion device 21 that supplies power to the hoisting machine 4 is controlled in such a way that the reactive current of the current supplied to the hoisting machine 4 has a value larger than that in the normal operation.

In step S32, the command generation unit 52 reads out one of the operation patterns from the storage unit 33. The information of the operation pattern includes an identifier for identifying the pattern, a control parameter, and a desired execution time of the efficient heat generation operation.

Next, in step S33, the command generation unit 52 outputs an efficient heat generation operation control command to the control unit 31 on the basis of the read operation pattern.

### <First Operation Pattern>

When the command generation unit 52 reads out the first operation pattern in step S33, the command generation unit 52 outputs a control command to the speed command generation unit 42 so that the absolute value of the accelerations of the car 1 is larger than that in the normal operation. Specifically, in the speed command for the normal operation, in order to shorten the time required to reach the maximum speed during the normal operation, a command is issued to make a correction to increase the amount of speed change per unit time. Alternatively, a command is issued to increase the maximum speed of the car 1 without changing the moving time of the car 1. By correcting the speed command in this manner, the absolute value of the acceleration of the car 1 becomes larger than that in the normal operation.

### <Second Operation Pattern>

When the command generation unit 52 reads out the second operation pattern in step S33, the command generation unit 52 outputs a command to the acquisition unit 41 and a door control unit (not shown) so that the travel distance of the car 1 per unit time is longer than that in the normal operation. Specifically, a command is output to the acquisition unit 41 so as to correct the destination floor registration, and a command is output to the door control unit (not shown) so as not to open the door of the car 1 even if the movement of the car 1 is stopped. When the destination floor registration is instructed such that the car 1 travels back and forth from the departure floor to the destination floor, the car 1 moves intermittently. Further, when the destination floor registration is instructed such that the travel distance of the car 1 is longer, the car 1 moves continuously.

### <Third Operation Pattern>

When the command generation unit 52 reads out the third operation pattern in step S33, the command generation unit 52 outputs a command to the current control unit 43b in such a way that the reactive current of the current supplied to the hoisting machine 4 has a value larger than that in the normal operation. Specifically, the reactive current is a current component that generates a magnetic flux in a direction opposite to the magnetic flux of the permanent magnet and is a d-axis current component in the current vector control. That is, the command generation unit 52 outputs a command for correcting the target value of the d-axis current so that the d-axis current component increases in a direction in which the magnetic flux of the permanent magnet is canceled.

In order to increase the amount of current per unit time flowing through the power conversion element of the power conversion device 21, the command generation unit 52 outputs the efficient heat generation operation control command to the control unit 31 in step S33, and when the efficient heat generation operation in step S13 is started, the process proceeds to step S34.

In step S34, the cooling effect of the power conversion device 21 is analyzed. The step S34 includes three steps of a step S341 to a step S343.

In step S341, the recording unit 53 acquires the temperature measurement value from the first temperature sensor 25, and calculates temperature rise amount ΔT on the basis of the temperature measurement value. Then, it is determined whether the temperature rise amount ΔT is equal to or larger than a temperature rise threshold ΔTth. Specifically, a temperature measurement value acquired from the first temperature sensor 25 immediately after the start of the efficient heat generation operation is stored in advance. A temperature measurement value is acquired from the first temperature sensor 25 every time one efficient heat generation operation is completed, and the temperature rise amount ΔT, which is a difference from the stored temperature measurement value, is calculated. Note that, the recording unit 53 may acquire temperature measurement values from the first temperature sensor 25 and the second temperature sensor 26 and calculate a difference between the temperature measurement values as the temperature rise amount ΔT. Specifically, a temperature measurement value acquired from the second temperature sensor 26 immediately after the start of the efficient heat generation operation is stored in advance. A temperature measurement value is acquired from the first temperature sensor 25 every time one efficient heat generation operation is completed, and the temperature rise amount ΔT, which is the difference from the stored temperature measurement value, is calculated.

The temperature rise threshold ΔTth referred to here is a value set for each elevator apparatus, and is a value that is not reached during normal operation, but is reached when efficient heat generation operation is performed. The temperature rise threshold ΔTth is preferably set to a value larger than the maximum value of the temperature rise amount ΔT reached when the normal operation is performed. The temperature rise threshold ΔTth may be set by a designer who designs the elevator apparatus or may be set by a maintenance staff who performs maintenance of the elevator apparatus.

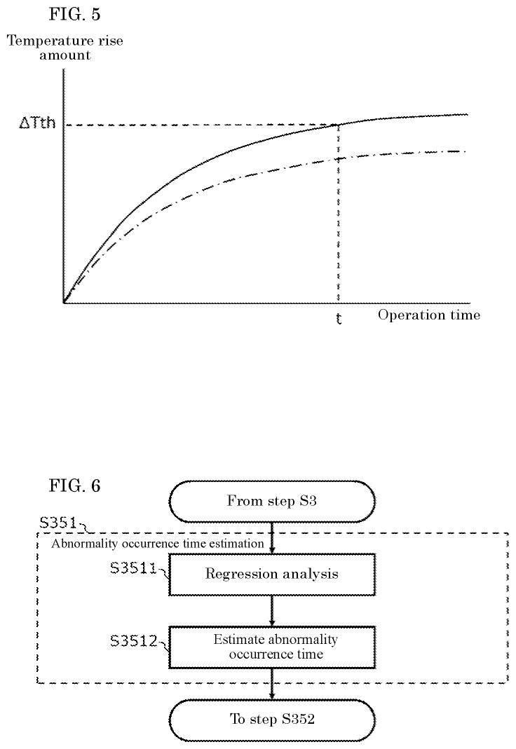

FIG. 5 shows the change in the temperature rise amount of the power conversion device 21 at the time of the cooling effect analysis. In FIG. 5, the horizontal axis represents the operation time, and the vertical axis represents the temperature rise amount ΔT. The solid line indicates the change in the temperature rise amount ΔT of the power conversion device 21 when the efficient heat generation operation is performed, and the long and short dashed line indicates the change in the temperature rise amount ΔT of the power conversion device 21 when the normal operation is performed.

If the calculated temperature rise amount ΔT is smaller than the temperature rise threshold ΔTth, the process proceeds to step S342. If the calculated temperature rise amount ΔT is equal to or greater than the temperature rise threshold ΔTth, the process proceeds to step S343.

In step S342, the command generation unit 52 determines whether the execution of the outputted operation pattern of the efficient heat generation operation is completed. The operation pattern of the efficient heat generation operation read out from the storage unit 33 by the command generation unit 52 includes a desired execution time. Accordingly, the command generation unit 52 determines whether the desired execution time has elapsed. This determination is made on the basis of the integrated value of the moving time of the car 1 as in step S343 described below, but may be made on the basis of the start time and end time obtained from the timer 34. When the efficient heat generation operation is executed by a plurality of efficient heat generation operation control commands, the end of execution may be determined on the basis of the number of times of the execution. The desired execution time is not limited as long as it is sufficient for diagnosis, but is, for example, 30 minutes to several hours. If the desired execution time has not elapsed, the process proceeds to step S33. If the desired execution time has elapsed, the process proceeds to step S343.

In step S343, the recording unit 53 records a temperature rise reaching time t, which is the time from the start of the cooling effect analysis to the time when the temperature rise amount ΔT reaches the temperature rise threshold ΔTth. Specifically, every time the efficient heat generation operation is completed, the recording unit 53 receives the moving time of the car 1 held by the speed command generation unit 42, and the recording unit 53 integrates the moving time of the car 1 from the start of the cooling effect analysis. This integration is performed until the temperature rise amount ΔT reaches the temperature rise threshold ΔTth, and the time when the process reaches step S343 is recorded. The recorded time is the temperature rise reaching time t. The integrated value of the moving time of the car 1 referred to here is not an integrated value of the time during which the car 1 is actually moving, but an integrated value of the time during which the power conversion device 21 is energized to move the car 1. That is, it is the integrated value of the energization time of the power conversion device 21. When the command generation unit 52 outputs the efficient heat generation operation control command to the control unit 31 in step S33, current flows through the power conversion device 21 even when the car 1 is in a stopped state. Therefore, the moving time of the car 1 includes a time in which the energization of the power conversion device 21 is started and the car 1 moves from the stopped state, and the movement of the car 1 is completed and the energization of the power conversion device 21 is completed. The recording unit 53 acquires the date and time at which the process of step S343 is performed from the timer 34 as the end date and time of the cooling effect diagnosis, and records the acquired date and time in association with the temperature rise reaching time t. When the recording unit 53 records the temperature rise reaching time t and the end time of the cooling effect diagnosis and transmits the recorded information to the past result database 55 as past data, the process proceeds to step S35.

In step S35, the result of the cooling effect analysis of the power conversion device 21 is determined. Step S35 includes five steps from step S351 to step S355.

In step S351, the determination unit 54 estimates the time when the cooling effect is to be abnormal. As shown in FIG. 6, step S351 includes two steps of step S3511 and step S3512.

In step S3511, the determination unit 54 reads out the past data of the past result database 55 and estimates a regression formula by regression analysis. At this time, the dependent variable is set to the temperature rise reaching time t, and the independent variable is set to the end date and time of the cooling effect diagnosis.

Next, in step S3512, the determination unit 54 estimates the time at which the cooling effect is to be abnormal using a time threshold tmin and the estimated regression formula. The time threshold tmin is a value set for each elevator apparatus, and is a reference value for determining that an abnormality has occurred in the cooling effect.

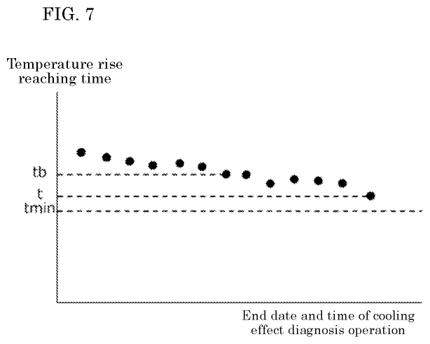

A graph plotting the past data stored in the past result database 55 is shown in FIG. 7. In FIG. 7, the horizontal axis represents the end date and time of the cooling effect diagnosis, and the vertical axis represents the temperature rise reaching time t. If appropriate maintenance work is performed, the value of the temperature rise reaching time t shifts without a large change. However, when there is a lot of dust in the elevator control device 20, the dust accumulates on the surfaces of the cooling fin 23 and the cooling fan 24, and the cooling effect on the power conversion device 21 is reduced. That is, as shown in FIG. 7, the temperature rise reaching time t shifts downward. When the end time in the cooling effect diagnosis at which the temperature rise reaching time t reaches the time threshold tmin is calculated from the estimated regression formula, the time when the abnormality occurs can be estimated.

Next, in step S352, the determination unit 54 determines whether the cooling effect is abnormal on the basis of the temperature rise reaching time t. Specifically, when the temperature rise reaching time t is equal to or less than the time threshold tmin, it is determined that the temperature rise reaching time t is out of the normal range, that is, it is determined that the cooling effect is abnormal. When the temperature rise reaching time t is greater than the time threshold tmin, the cooling effect is determined to be normal. Another method of the determination is not to use the time threshold tmin. The determination unit 54 reads out the past data held in the past result database 55, calculates the difference between the past data and the newly measured temperature rise reaching time t, and determines an abnormality using the difference Δtdiv. When the determination is made using the difference Δtdiv, it is determined whether the difference Δtdiv is over the normal range using the difference threshold Δtdivth. The difference threshold Δtdivth is a value set for each elevator apparatus and is a reference value for determining that an abnormality has occurred in the cooling effect. When the difference Δtdiv is greater than or equal to the difference threshold Δtdivth, it is determined that the cooling effect is abnormal, and when the difference Δtdiv is smaller than the difference threshold Δtdivth, it is determined that the cooling effect is normal. If it is determined to be abnormal, the process proceeds to step S353. If it is determined to be normal, the process proceeds to step S38.

In step S353, the determination unit 54 determines whether or not an emergency response is required on the basis of the rate of change of the temperature rise reaching time t. Specifically, the determination unit 54 reads out the past data held in the past result database 55. Next, as shown in FIG. 7, the determination unit 54 selects a temperature rise reaching time tb to be compared. Thereafter, the determination unit 54 calculates the difference between the temperature rise reaching time tb of the past data and the temperature rise reaching time t as a temperature rise reaching time change amount. The difference in the end date and time in the cooling effect diagnosis corresponding to each of the temperature rise reaching times tb and t is calculated as the elapsed time change amount. Finally, the temperature rise reaching time change amount is divided by the elapsed time change amount to calculate a temperature rise reaching time change rate a.

The necessity of emergency response is determined from the calculated temperature rise reaching time change rate a and a change rate threshold ath. The change rate threshold ath is a value set for each elevator apparatus and is a reference value for determining whether or not an emergency response is required. The change rate threshold ath may be set by a designer who designs the elevator apparatus or by a maintenance staff who performs maintenance of the elevator apparatus. The determination unit 54 compares the absolute value of the temperature rise reaching time change rate a with the change rate threshold ath, and if the absolute value of the temperature rise reaching time change rate a is equal to or greater than the change rate threshold ath, the process proceeds to step S354. If the absolute value of the temperature rise reaching time change rate a is smaller than the change rate threshold ath, the process proceeds to step S355.

In step S354, the determination unit 54 determines that the power conversion device 21 is in the warning state and requests an emergency response from a maintenance staff. That is, when the temperature rise reaching time t is equal to or greater than the time threshold tmin and the absolute value of the temperature rise reaching time change rate a is equal to or greater than the change rate threshold ath in step S353, the power conversion device 21 is in the warning state and is determined to request an emergency response. At this time, the determination unit 54 estimates that the cause of the abnormality is a sudden malfunction of the cooling fan 24. The determination unit 54 stores warning type information in the memory so that a signal indicating that an emergency response is required can be output in step S38 to be described later. The warning type information is, for example, warning information that identifies the component to be cooled and indicates an emergency, such as information indicating an abnormality in the cooling fan 24, or warning information indicating that an emergency response is required. Then, the process proceeds to step S36.

In step S355, the determination unit 54 determines that the power conversion device 21 is in the warning state but does not require an emergency response. That is, when the temperature rise reaching time t is equal to or greater than the time threshold tmin and the absolute value of the temperature rise reaching time change rate a is smaller than the change rate threshold ath in step S353, the power conversion device 21 is in the warning state, but it is determined that an emergency response by a maintenance staff is not required. At this time, the determination unit 54 estimates that the cause of the abnormality is a state in which a large amount of dust is attached to the cooling fan 24 or clogging due to dust entering the cooling fin 23. The determination unit 54 stores the estimation result in the memory as warning type information. The warning type information stored here is, for example, warning information that identifies the component to be cooled, such as information indicating an abnormality in the cooling fin 23, or warning information indicating a state in which an emergency response is not required. Then, the process proceeds to step S36.

In step S36, the reflection unit 56 reads out from the storage unit 33 the operation pattern of the suppression operation for suppressing the heat generation of the power conversion device 21 more than the normal operation. The suppression operation is an operation of controlling the car 1 in such a way that the heat load on the component to be cooled is reduced at an output suppressed compared with the normal operation. For the purpose above, it is necessary to reduce the amount of current flowing into the power conversion element of the power conversion device 21 per unit time. The following three examples are given as examples of the operation patterns of the suppression operation.

The first is a fourth operation pattern in which the opening and closing time of the door of the car 1 is made longer than that in the normal operation. The second is a fifth operation pattern in which the absolute value of the acceleration of the car 1 is made smaller than that in the normal operation. The third is a sixth operation pattern in which the speed of the car 1 of the elevator apparatus is set to be smaller than that in the normal operation. When at least one operation pattern of the suppression operation is read out, the process proceeds to step S37. The suppression operation may reduce the operating efficiency of the elevator apparatus. Therefore, the operation pattern of the suppression operation may be selected on the basis of the temperature rise reaching time change rate a, or a plurality of operation patterns of the suppression operation may be combined.

In step S37, the reflection unit 56 outputs a suppression operation control command to the control unit 31 on the basis of the read operation pattern.

### <Fourth Operation Pattern>

When the suppression operation is performed in the fourth operation pattern, the reflection unit 56 outputs a command to the door control unit (not shown) to make the opening and closing time of the door of the car 1 longer than that in the normal operation. Specifically, the setting is changed so that the time required for opening and closing the door of the car 1 controlled by the conventional control system is longer than that in the normal operation.

### <Fifth Operation Pattern>

When the suppression operation is performed in the fifth operation pattern, the reflection unit 56 outputs a control command to the speed command generation unit 42 so that the absolute value of the acceleration of the car 1 is smaller than that in the normal operation. Specifically, regarding the speed command for the normal operation, the reflection unit issues a command for the correction so as to reduce the speed change amount per unit time or acceleration in the car 1. By correcting the speed command in this manner, the absolute value of the acceleration of the car 1 is smaller than that in the normal operation.

### <Sixth Operation Pattern>

When the suppression operation is performed in the sixth operation pattern, the reflection unit 56 outputs a control command to the speed command generation unit 42 so that the speed of the car 1 is smaller than that in the normal operation. Specifically, among the speed commands for the normal operation, a command is issued to correct the maximum speed of the car 1 to be smaller or to correct the acceleration time to be shorter, so that the moving time of the car 1 is to be longer. By correcting the speed command in this manner, the speed of the car 1 is smaller than that in the normal operation in the case where the travel distance of the car 1 is the same as that in the normal operation.

When the suppression operation control command for reducing the amount of current per unit time flowing through the power conversion element of the power conversion device 21 is output from the reflection unit 56 to the control unit 31, the process proceeds to step S38.

In step S38, the reflection unit 56 outputs to the alarm device 14, a signal for requiring warning, a signal for requesting an emergency response, and the abnormality occurrence time as the diagnosis data. At this time, the abnormality occurrence time estimated by the determination unit 54 as the diagnosis data is output regardless of the determination result. The diagnosis data is not limited to the abnormality occurrence time and may include the temperature rise reaching time recorded by the recording unit 53 and the past data held by the past result database 55. Further, the signal for requesting the emergency response includes the warning type information stored in step S354 and step S355. If the state is not the warning state, information indicating no abnormality is set to the warning type information.

The reflection unit 56 transmits basic specification information of the elevator apparatus, the operation information, and the diagnosis data based on the temperature measurement value obtained from the first temperature sensor 25 during the efficient heat generation operation to the external database 15a of the external server 15. The basic specification information includes the rated speed, the load capacity, and the lifting stroke of the car 1. The operation information includes the number of times the elevator is activated, the travel distance of the car 1, or the total traveling time of the car 1. The diagnosis data includes the abnormality occurrence time estimated by the determination unit 54, the temperature rise reaching time recorded by the recording unit 53, or the past data held in the past result database 55.

The external database 15a stores basic specification information, operation information, and diagnosis data of a plurality of elevator apparatuses. The external diagnosis unit 15b reads out the basic specification information or the operation information of the elevator apparatus to be diagnosed from the external database 15a and selects a similar elevator apparatus from the elevator apparatuses stored in the external database 15a. The similar elevator apparatus is an elevator apparatus having similar basic specification information or similar operation information. For example, when the rated speed of the car 1 in the basic specification information and the total traveling time of the car 1 in the operation information for an elevator apparatus to be diagnosed are similar to those of other elevator apparatuses, the other elevator apparatuses are determined to be similar elevator apparatuses.

When a similar elevator apparatus is selected, the external diagnosis unit 15b compares the diagnosis data of the elevator apparatus to be diagnosed with that of the similar elevator apparatus, and diagnoses the cooling effect of the power conversion device 21. In the cooling effect diagnosis performed by the external diagnosis unit 15b, for example, comparison on the abnormality occurrence time estimated by the determination unit 54 is made. If the time when the abnormality occurrence time in the elevator apparatus to be diagnosed is shorter than that in the similar elevator apparatus by six months or more, the warning state is determined, and the signal indicating the warning state is output to the alarm device 14.

When the reflection unit 56 outputs the signal and the diagnosis data to the alarm device 14, the process proceeds to step S31 again.

### Details of Operation Control

Hereinafter, the operation control of the elevator apparatus will be described with reference to FIG. 8. FIG. 8 is a flowchart showing details of the operation control by the control unit 31. This flowchart shows the process corresponding to each of the control of the normal operation in step S12, the control of the efficient heat generation operation in step S13, and the control of the suppression operation in step S14 in FIG. 3. First, the control during the normal operation will be described as a representative control of these three, and then the control different from the normal operation will be described for the control of the efficient heat generation operation and the control of the suppression operation.

### Normal Operation.

The step S12 will be described in detail with reference to FIG. 8. Step S12 includes three steps, steps S21 to S23.

In step S21, the acquisition unit 41 acquires destination floor registration information from the car operation panel 8 and call registration information from the hall operation panel 10 via the input/output interface (not shown). The acquisition unit 41 holds the information obtained from these registrations as the operation management information. The operation management information is information that changes depending on passengers using the elevator apparatus. Specifically, the operation management information is the destination floor registration performed by operating the destination floor registration button 9 of the car operation panel 8, and the call registration performed by operating the call registration button 11 of the hall operation panel 10. Further, the acquisition unit 41 may acquire information on the load in the car 1 from the weighing device 12 through the input/output interface (not shown) to be included in the operation management information. Unless the acquisition unit 41 acquires the operation management information in step S21, step S21 is repeated. When the acquisition unit 41 acquires the operation management information, the process proceeds to step S22 and step S23.

In step S22, the movement of the car 1 is controlled. In step S23, the control unit 31 controls the opening and closing of the door of the car 1. The door of the car 1 is opened and closed by using a conventional control system in which the opening and closing of the door is controlled by using a position sensor of the car 1 in the hoistway.

Step S22 includes five steps from step S221 to step S225. In the following description, for convenience of description, the process is described in the order of parameters passed by each module, but the process of each of the five steps does not need to be executed sequentially, and the process of each step is repeatedly executed in parallel and at a frequency necessary for the control, for example, in cycles of several microseconds to several hundred microseconds. The five steps are executed while one operation pattern is executed.

In step 221, the speed command generation unit 42 creates a speed command for controlling the speed of the car 1 on the basis of the destination floor registration and the call registration of the operation management information held by the acquisition unit 41. Specifically, since the destination floor is specified by the destination floor registration and the call registration, the number of rotations per unit time of the motor 5 provided in the hoisting machine, etc. is instructed in accordance with the moving distance to the destination floor and the position of the car 1. When the speed command is generated, the process proceeds to step S222.

In step S222, the speed control unit 43a calculates the speed deviation based on the speed command generated by the speed command generation unit 42 and the rotation speed of the motor 5 detected by the speed detector 7. Specifically, first, the rotation speed of the motor 5 detected by the speed detector 7 is received via the input/output interface (not shown). Next, the speed deviation is calculated from the rotation speed and the speed command that are received. The speed deviation referred to here is a deviation between the speed command as a target value and the rotation speed of the motor 5 as a control value. When the speed deviation is calculated, the process proceeds to step S223.

In step S223, the speed control unit 43a calculates a target value of the q-axis current, which is referred to as a current in the current vector control necessary for the rotation speed of the motor 5 to follow the speed command, on the basis of the speed deviation calculated in step S222. For example, feedback control for calculating a target value of the q-axis current is performed using a known proportional-integral-differential (PID) control algorithm, such as creating a torque current command for generating a required torque on the basis of the speed command. When the target value of the q-axis current is calculated, the process proceeds to step S224.

In step S224, the current control unit 43b creates a voltage command for controlling the current supplied from the power conversion device 21 to the motor 5 of the hoisting machine 4 and the voltage applied to the motor 5, on the basis of the target value of the q-axis current calculated by the speed control unit 43a, the measurement value of the motor current obtained from the current detector 22, and the rotation speed of the motor 5 detected by the speed detector 7. Specifically, for example, the current control unit 43b receives a measurement value of the motor current detected by the current detector 22 and a rotation speed of the motor 5 detected by the speed detector 7 via the input/output interface (not shown). The received motor current of the measurement value is decomposed into the q-axis current, which is a current component contributing to motor torque generation, and a d-axis current, which is a current component of the permanent magnet flux axis, by a known current vector control algorithm, such as converting the motor current measurement value into two phase current values and performing rotating coordinate conversion using the rotation angle of the rotor of the motor 5. The rotation angle of the rotor of the motor 5 is calculated on the basis of the rotation speed of the motor 5 detected by the speed detector 7. Next, a target value of the d-axis current is generated. As a method for generating the target value, for example, the target value is set so that the d-axis current becomes zero in the normal operation. The d-axis current component can be regarded as a current component that does not contribute to the generation of motor torque with respect to the q-axis current component. Finally, a voltage command necessary for the measurement value of the motor current of each axis to coincide with the target value of the motor current of each axis is calculated. This voltage command is a command for so-called PWM control and includes information of a switching duty ratio for the voltage in accordance with a desired output.

In step S225, the current control unit 43b outputs the created voltage command to the power conversion device 21. Accordingly, the power conversion device 21 is controlled such that the motor current value detected by the current detector 22 coincides with the motor current target value. When the voltage command is output, the process proceeds to step S11 again.

### Efficient Heat Generation Operation

Next, control different from the normal operation will be described with respect to the efficient heat generation operation. First, control common to all the operation patterns will be described. When the efficient heat generation operation command is received from the cooling effect diagnosis unit 32, the acquisition unit 41 performs a destination floor registration according to the command. The destination floor registration is normally performed on the basis of a signal from the car operation panel 8, but in the efficient heat generation operation, the acquisition unit 41 performs the destination floor registration, not depending on the signal from the car operation panel 8. The destination floor to be registered may be determined by the acquisition unit 41 on the basis of the information of the destination floor included in the control parameter of the efficient heat generation operation command, or the acquisition unit 41 may register a destination floor set in advance. The destination floor registration is performed such that, for example, one round trip is made between the lowest floor and the highest floor.

Next, control unique to each operation pattern will be described.

### <First Operation Pattern>

If the speed command generation unit 42 has received the control command of the first operation pattern from the command generation unit 52, the speed command generation unit 42 modifies the speed command in step S221. For example, the acceleration or the maximum speed of the car 1 is corrected to be higher than that in the normal operation. In the normal operation, if the absolute value of the acceleration of the car 1 is increased, the passengers may feel uncomfortable due to the acceleration or uncomfortable due to the change in the air pressure, such as ringing in the ears. Therefore, typically, the speed command generated by the speed command generation unit 42 is suppressed to a range that does not cause discomfort in the normal operation. In the efficient heat generation operation of this embodiment, this limitation is eliminated, and the speed command generation unit 42 makes the absolute value of the acceleration or the maximum speed of the car 1 larger than that in the normal operation. The value for the increase may be a predetermined value or may be in accordance with the control parameter included in the efficient heat generation operation command. By correcting the speed command in this manner, the absolute value of the acceleration of the car 1 is larger than that in the normal operation.

### <Second Operation Pattern>

When the acquisition unit 41 has received the control command of the second operation pattern from the command generation unit 52, the control unit 31 moves the car 1 continuously or at a high frequency so that a higher load is applied to the component to be cooled than in the normal operation. For example, the acquisition unit 41 generates a destination floor registration and makes the car 1 go back and forth from the lowest floor to the highest floor. At this time, the destination floor is registered such that the stop time at a hall is eliminated or the stop time is shorter than that in the normal operation to control the car 1. That is, the car 1 is moved so that the travel distance of the car 1 per unit time is longer. Specifically, the following procedure is repeatedly performed: the destination floor registration for the highest floor is performed before the descending car 1 arrives at the lowest floor, and the car 1 is raised such that the stop time is shorter than that in the normal operation. In addition, it is further preferable that the control unit 31 controls the drive device for opening and closing the door of the car 1 so that the door of the car 1 does not open even when the car 1 arrives at the destination floor. This is because, when the door is open, the control unit 31 performs safety control to prevent the car 1 from moving during normal operation, but when the door is not opened even after the car 1 arrives at the destination floor, the car 1 can be moved immediately. This control eliminates the stop time or makes it shorter than that in the normal operation and allows the car 1 to move to the next destination floor. A known door control device can be used for controlling the door of the car 1.

As another example of the second operation pattern, the acquisition unit 41 may generate a plurality of destination floor registrations so that the car 1 stops on each floor, and control may be performed such that the car 1 repeats movement and stops on each floor. At this time, the stop time is set to zero or shorter than that in the normal operation in the door closed state. In this case, since the component to be cooled such as the power conversion device 21 can be driven at high frequency per unit time, the component to be cooled can be efficiently heated. Although the example in which the acquisition unit 41 performs the destination floor registration in a pseudo manner has been described in the above description, the car 1 may be caused to travel in a specific pattern by using another method, such as the speed command generation unit 42 generating the speed command without using the acquisition unit 41, as long as the travel distance per unit time or the acceleration/deceleration time of the car 1 can be increased.

### <Third Operation Pattern>

When the current control unit 43b has received the control command of the third operation pattern from the command generation unit 52, the current control unit 43b corrects the target value of the d-axis current with respect to the target value in the normal operation in such a way that the reactive current is larger than that in the normal operation. Specifically, when the target value of the d-axis current is to be generated, a correction is made to increase the d-axis current value that generates a magnetic flux in a direction opposite to the magnetic flux of the permanent magnet. The correction amount of the target value of the motor current may be a predetermined value or may be in accordance with the control parameter included in the efficient heat generation operation command.

### Suppression Operation

Next, regarding the suppression operation, control different from that of the normal operation will be described.

### <Fourth Operation Pattern>

When the control unit 31 has received the control command of the fourth operation pattern from the reflection unit 56, the control unit 31 controls the door of the car 1 in step S23 so that the time required for opening the door and the time required for closing the door of the car 1 are longer than those in the normal operation. Since the stop time of the car 1 is preferably long, the control unit 31 may control the timing of closing the door in such a way that the door is opened longer than in the normal operation at a floor of a hall.

### <Fifth Operation Pattern>

When the speed command generation unit 42 has received the control command of the fifth operation pattern from the reflection unit 56, the speed command generation unit 42 changes the speed command in the same manner as the second operation pattern in step S221. However, the speed command generation unit 42 generates the speed command on the basis of the actual call registration and destination floor registration, and corrects the speed command in such a way that the absolute value of the acceleration indicated by the speed command is smaller than that in the normal operation.

### <Sixth Operation Pattern>

When the speed command generation unit 42 has received the control command of the sixth operation pattern from the reflection unit 56, the speed command generation unit 42 changes the speed command in the same manner as the fifth operation pattern in step S221. However, the speed command generation unit 42 corrects the speed instructed by the speed command in such a way that the speed is smaller than that in the normal operation.

As described above, in the elevator control device 20 of Embodiment 1, when the cooling effect diagnosis is performed, the efficient heat generation operation in which the component to be cooled generates heat more than that in the normal operation is performed, so that the value of the temperature rise reaching time t is likely to change, and an abnormality can be detected at an early stage. For example, even when the abnormality of the power conversion device 21 is difficult to appear as a change in the temperature measurement value, such as when a part of the thermal interface material provided between the power conversion element of the power conversion device 21 and the cooling fin 23 is deteriorated or when the abnormality of the power conversion element of the power conversion device 21 is slight, the change in the value of the temperature rise reaching time t is likely to appear, and the abnormality can be detected at an early stage. Even when it is difficult to accurately measure the temperature, for example, when the temperature sensor is located away from the power conversion device 21, the value of the temperature rise reaching time t is likely to change, and an abnormality can be detected at an early stage.

Further, in the elevator control device 20 according to Embodiment 1, when the temperature rise amount ΔT is equal to or greater than the temperature rise threshold ΔTth, the efficient heat generation operation is terminated. That is, it is possible to control the component to be cooled so as not to generate heat more than necessary, and it is possible to suppress the failure of the component to be cooled due to excessive heating.

Furthermore, in the elevator control device 20 according to Embodiment 1, the cause of the abnormality of the elevator control device 20 can be estimated by calculating the temperature rise reaching time t and the rate of change thereof from the temperature measurement value obtained from the single first temperature sensor 25.

Furthermore, in the elevator control device 20 according to Embodiment 1, since the time at which an abnormality is to occur in the cooling effect is predicted regardless of the presence or absence of an abnormality and is output as diagnosis data, a maintenance staff can perform maintenance of the elevator control device 20 with planning.

Furthermore, in the elevator control device 20 according to Embodiment 1, since a signal for requesting an emergency response is output, it is possible to assist the determination of the work priority when maintenance of the elevator control device 20 is performed.

Further, the elevator control device 20 according to Embodiment 1 outputs a control command to perform the suppression operation when it is determined that an abnormality has occurred in the cooling effect diagnosis. This reduces the load on the component to be cooled until maintenance is performed and allows the elevator apparatus to be operated longer than in the case where the normal operation continues to be operated.

Further, in the elevator control device 20 according to Embodiment 1, even if the number of the first temperature sensors 25 is one, the cause of the abnormality of the component to be cooled can be estimated. Therefore, when maintenance of the elevator control device 20 is performed, preparation in response to the cause of the abnormality can be performed.

Furthermore, in the elevator control device 20 according to Embodiment 1, the external server 15 can detect an abnormality by comparing the diagnosis data with diagnosis data of a similar elevator apparatus.

Note that the component to be cooled is not limited to the power conversion device 21 and may be any component that is cooled by the cooling fan 24, such as an electronic device mounted with an electrolytic capacitor or a battery.

Note that, as a method for the start determination unit 51 to determine the start of the cooling effect diagnosis, the start determination unit 51 may acquire the load in the car 1 obtained from the weighing device 12 as the operation management information to determine the start of the cooling effect diagnosis or may acquire the temperature measurement value of the power conversion device 21 from the first temperature sensor 25 to determine the start of the cooling effect diagnosis. In addition, the date on which the cooling effect diagnosis is started may be set in advance, or the resting state may be determined from the past operation management information.

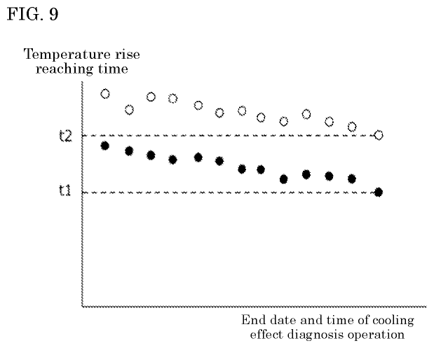

In addition to the first temperature sensor 25, a third temperature sensor (not shown) for measuring the heat radiation temperature of a component to be cooled in the elevator control device 20 may be provided. When the third temperature sensor is provided, temperature rise reaching times t1 and t2 at two points can be measured by one cooling effect diagnosis. Plotting the past data accumulated in the past result database 55 results in a graph as shown in FIG. 9. In FIG. 9, the black circles represent past data based on the first temperature sensor 25, and the white circles represent past data based on the third temperature sensor. Since two regression formulas are estimated in step S351, abnormality detection can be performed using these formulas. Specifically, the determination unit 54 compares the values of the slopes of the regression formulas and determines the cooling effect to be abnormal if the difference is equal to or greater than a predetermined value. In order to determine the abnormality, not the slope of the regression formula, but a value obtained from the regression formula, such as a determination coefficient, may be used. The number of temperature sensors for measuring the heat radiation temperature of a component to be cooled in the elevator control device 20 is not limited to one or two, and three or more temperature sensors may be provided.

### Embodiment 2

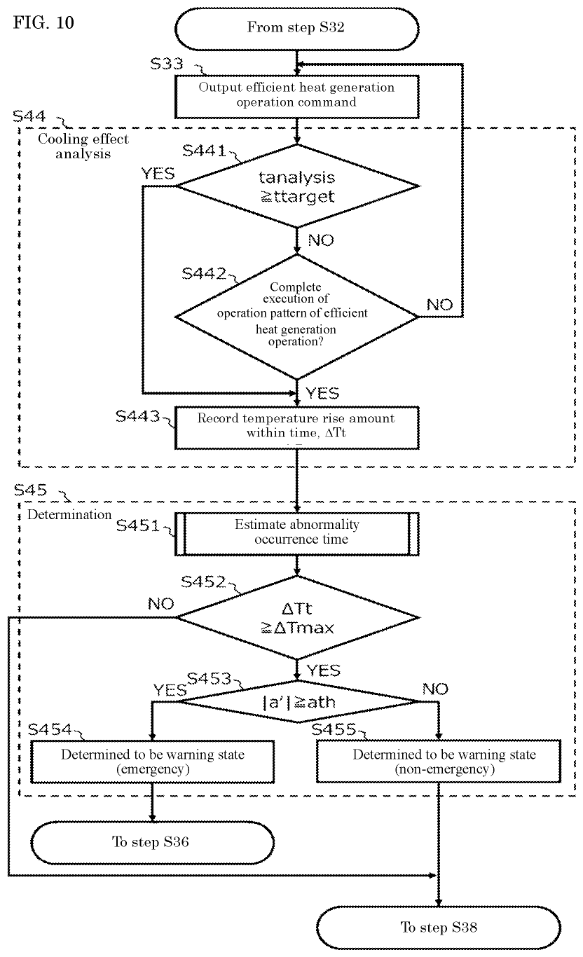

While the elevator control device 20 of Embodiment 1 performs the cooling effect diagnosis using the temperature rise reaching time t, a different diagnosis method, that is, a method of performing the cooling effect diagnosis using a temperature rise amount within time, ΔTt, will be described in Embodiment 2. Specifically, since the cooling effect analysis process in step S34 and the determination process in step S35 in FIG. 4 are different, these processes will be described with reference to FIG. 10.

FIG. 10 is a flowchart showing processes different from those of Embodiment 1 among the process of the cooling effect diagnosis unit 32 shown in FIG. 4. Step S44 is a cooling effect diagnosis process executed instead of step S34 of FIG. 4 and includes three steps of step S441 to step S443.

In step S441, the recording unit 53 acquires the moving time of the car 1 from the speed command generation unit 42 via the input/output interface. Next, an operation time tanalysis is calculated on the basis of the obtained moving time, and it is determined whether a time ttarget has elapsed. Specifically, every time the efficient heat generation operation is completed, the recording unit 53 receives the moving time of the car 1 held by the speed command generation unit 42, and the recording unit 53 integrates the moving time of the car 1 from the start of the cooling effect analysis to calculate the operation time tanalysis. This integration is performed until the operation time tanalysis reaches the time ttarget.

The time ttarget is a value set for each elevator apparatus and is a time sufficient to diagnose the cooling effect. The time ttarget may be set by a designer who designs the elevator apparatus or by a maintenance staff who performs maintenance of the elevator apparatus.

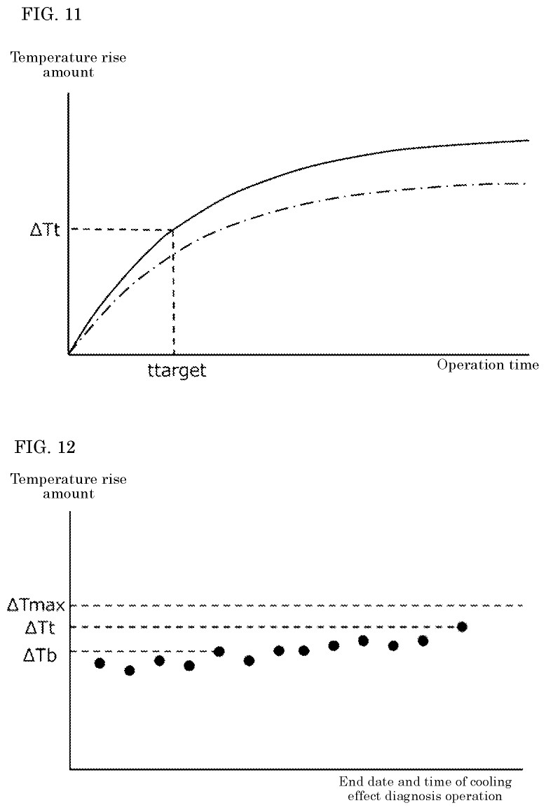

FIG. 11 shows a change in the temperature rise amount of the power conversion device 21 at the time of the cooling effect analysis. In FIG. 11, the horizontal axis represents the operation time, and the vertical axis represents the temperature rise amount ΔT. The solid line indicates the change in the temperature rise amount ΔT of the power conversion device 21 when the efficient heat generation operation is performed, and the long and short dashed line indicates the change in the temperature rise amount ΔT of the power conversion device 21 when the normal operation is performed.

If the operation time tanalysis is smaller than the time ttarget, the process proceeds to step S442. If the operation time tanalysis is equal to or greater than the time ttarget, the process proceeds to step S443.

In step S442, the command generation unit 52 determines whether the execution of the outputted operation pattern of the efficient heat generation operation is completed. The operation pattern of the efficient heat generation operation read out from the storage unit 33 by the command generation unit 52 includes a desired execution time. Thus, the command generation unit 52 determines whether the desired execution time has elapsed. If the desired execution time has not elapsed, the process proceeds to step S33. If the desired execution time has elapsed, the process proceeds to step S443.

In step S443, the recording unit 53 acquires the temperature measurement value from the first temperature sensor 25 and calculates the temperature rise amount ΔT at the time ttarget, that is, the temperature rise amount within time, ΔTt. Specifically, the recording unit 53 stores in advance, the temperature measurement value acquired from the first temperature sensor 25 immediately after the start of the efficient heat generation operation and obtains the change amount between the stored temperature measurement value and the temperature measurement value at the time ttarget. This change amount is the temperature rise amount within time, ΔTt. Further, the recording unit 53 acquires the date and time at which the process of step S443 is performed from the timer 34 as the end date and time of the cooling effect diagnosis and records the acquired date and time in association with the temperature rise amount within time, ΔTt. When the recording unit 53 records the temperature rise amount within time, ΔTt, and the end time of the cooling effect diagnosis and transmits the recorded information to the past result database 55 as past data, the process proceeds to step S45.

Step S45 is a determination process executed instead of step S35 in FIG. 4 and is a process of determining the result of the cooling effect analysis of the power conversion device 21. Step S45 includes five steps from step S451 to step S455.

In step S451, the determination unit 54 estimates an abnormality occurrence time of the power conversion device 21 as in step S351.

A graph plotting the past data stored in the past result database 55 is shown in FIG. 12. In FIG. 12, the horizontal axis represents the end date and time of the cooling effect diagnosis, and the vertical axis represents the temperature rise amount ΔT. If appropriate maintenance work is performed, the value of the temperature rise amount within time, ΔTt, shifts without a significant change. However, when there is a lot of dust in the elevator control device 20, the dust accumulates on the surfaces of the cooling fin 23 and the cooling fan 24, and the cooling effect on the power conversion device 21 is reduced. That is, as shown in FIG. 12, the temperature rise amount within time, ΔTt, shifts upward to the right. When the end date and time of the cooling effect diagnosis at which the temperature rise amount ΔT reaches a rise amount threshold value ΔTmax is calculated from the estimated regression formula in the step S451 where the estimation is performed, the abnormality occurrence time can be estimated. After estimating the abnormality occurrence time, the process proceeds to step S452.

In step S452, the determination unit 54 determines whether the temperature rise amount within time, ΔTt, exceeds the normal range, that is, whether it is abnormal, using the rise amount threshold value ΔTmax. When the temperature rise amount within time, ΔTt, is equal to or greater than the rise amount threshold value ΔTmax, it is determined that the cooling effect is abnormal, and when the temperature rise amount within time, ΔTt, is smaller than the rise amount threshold value ΔTmax, it is determined that the cooling effect is normal. Another determination method is a method that does not use the rise amount threshold value ΔTmax. The determination unit 54 reads out the past data held in the past result database 55, calculates the difference between the past data and the newly measured temperature rise amount within time, ΔTt, and determines the abnormality using the difference ΔTdiv. When the determination is performed using the difference ΔTdiv, it is determined whether the difference ΔTdiv exceeds the normal range using a difference threshold ΔTdivth. The difference threshold ΔTdivth is a value set for each elevator apparatus and is a reference value for determining that an abnormality has occurred in the cooling effect. When the difference ΔTdiv is greater than or equal to the difference threshold ΔTdivth, it is determined that the cooling effect is abnormal, and when the difference ΔTdiv is smaller than the difference threshold ΔTdivth, it is determined that the cooling effect is normal. If the cooling effect is determined to be abnormal, the process proceeds to step S453.

If it is determined to be normal, the process proceeds to step S38.

In step S453, the determination unit 54 determines whether or not an emergency response is required on the basis of the rate of change of the temperature rise amount within time, ΔTt. Specifically, the determination unit 54 reads out the past data held in the past result database 55. Next, as shown in FIG. 12, the determination unit 54 selects, for a comparison, a temperature rise amount within time, ΔTb. Thereafter, the determination unit 54 calculates the difference between the temperature rise amount within time, ΔTb, of the past data and the temperature rise amount within time, ΔTt, as the temperature rise amount change amount. In addition, the difference between the end dates and times of the cooling effect diagnosis corresponding to the respective temperature rise amounts within time, ΔTb and ΔTt, is calculated as the elapsed time change amount. Finally, the temperature rise amount change amount is divided by the elapsed time change amount to calculate a temperature rise amount change rate a′.

The necessity of emergency response is determined from the calculated temperature rise amount change rate a′ and a change rate threshold ath. The determination unit 54 compares the absolute value of the temperature rise amount change rate a′ with the change rate threshold ath, and if the absolute value of the temperature rise amount change rate a′ is equal to or greater than the change rate threshold ath, the process proceeds to step S454. If the temperature rise amount change rate a′ is smaller than the change rate threshold ath, the process proceeds to step S455.

In step S454, the determination unit 54 performs the same process as in step S354. In step S455, the determination unit 54 performs the same process as in step S355.

In the elevator control device 20 according to Embodiment 2 configured as described above, since the efficient heat generation operation in which the component to be cooled generates heat more than in the normal operation is performed when the cooling effect diagnosis is performed, the value of the temperature rise amount within time, ΔTt, is likely to change, and an abnormality can be detected at an early stage. For example, even in a case where the abnormality of the power conversion device 21 is difficult to appear as a change in the temperature measurement value, such as a case where a part of the thermal interface material provided between the power converter element of the power conversion device 21 and the cooling fin 23 is deteriorated or the abnormality of the power conversion element of the power conversion device 21 is slight, the change in the value of the temperature rise amount within time, ΔTt, is likely to appear, and the abnormality can be detected at an early stage. Even when it is difficult to accurately measure the temperature, for example, when the temperature sensor is located away from the power conversion device 21, the value of the temperature rise amount within time, ΔTt, is likely to change, and an abnormality can be detected at an early stage.

In the elevator control device 20 according to Embodiment 2, since the diagnosis time can be set in advance, it is possible to suppress a decrease in the operating efficiency of the elevator apparatus.

In Embodiment 2 described above, as in Embodiment 1, the component to be cooled is not limited to the power conversion device 21 and may be any component cooled by the cooling fan 24, such as an electronic device mounted with an electrolytic capacitor or a battery.

In Embodiment 2, as in Embodiment 1, the start determination unit 51 may determine the start of the cooling effect diagnosis by acquiring the load in the car 1 obtained from the weighing device 12 as the operation management information or may determine the start of the cooling effect diagnosis by acquiring the temperature measurement value of the power conversion device 21 from the first temperature sensor 25. In addition, the date on which the cooling effect diagnosis is started may be set in advance, or the resting state may be determined from the past operation management information.

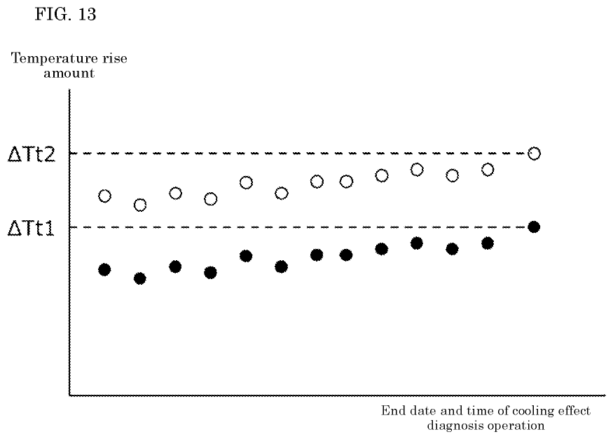

In Embodiment 2 described above, a third temperature sensor (not shown) for measuring the heat radiation temperature of a component to be cooled in the elevator control device 20 may be provided in addition to the first temperature sensor 25. When the third temperature sensor is provided, the temperature rise amounts within time, ΔTt1 and ΔTt2, at two locations can be measured by one cooling effect diagnosis. Plotting the past data accumulated in the past result database 55 results in a graph as shown in FIG. 13. In FIG. 13, the black circles represent the past data based on the first temperature sensor 25, and the white circles represent the past data based on the third temperature sensor. Since two regression formulas are estimated in step S451, abnormality detection can be performed using these formulas. Specifically, the determination unit 54 compares the values of the slopes of the regression formulas and determines the cooling effect to be abnormal if the difference is equal to or greater than a predetermined value. In order to determine the abnormality, not the slope of the regression formula, but a value obtained from the regression formula, such as a determination coefficient, may be used. The number of temperature sensors for measuring the heat radiation temperature of a component to be cooled in the elevator control device 20 is not limited to one or two, and three or more temperature sensors may be provided.

### DESCRIPTION OF REFERENCE NUMERALS AND SIGNS

1: car, 4: hoisting machine, 15: external server, 15a: external database, 16: communication device, 20: elevator control device, 21: power conversion device, 23: cooling fin, 24: cooling fan, 25: first temperature sensor, 26: second temperature sensor, 31: control unit, 32: cooling effect diagnosis unit, 54: determination unit, 55: past result database, 56: reflection unit

1. An elevator control device comprising:
a cooling fan;
a component to be cooled that is used for drive control of a hoisting machine and is cooled by the cooling fan;
a temperature sensor to measure a temperature of the component to be cooled;
a processor to execute a program including software modules; and
a memory to store the program which, when executed by the processor, performs processes of,
controlling to drive and control the hoisting machine and to perform a normal operation and an efficient heat generation operation of causing the component to be cooled to generate heat for diagnosis to a temperature higher than a temperature during the normal operation; and
diagnosing a cooling effect of the component to be cooled on a basis of temperature measurement values obtained from the temperature sensor during the efficient heat generation operation.

2. The elevator control device according to claim 1, wherein the program drives and controls the hoisting machine in such a way that an absolute value of an acceleration of a car in the efficient heat generation operation is larger than that in the normal operation.

3. The elevator control device according to claim 1, wherein the program controls a door of a car to be closed in the efficient heat generation operation and drives and controls the hoisting machine continuously or intermittently in such a way that a travel distance of the car per unit time is longer than that in the normal operation.

4. The elevator control device according to claim 1, wherein the program controls a power conversion device for supplying power to the hoisting machine in such a way that a reactive current of a current supplied to the hoisting machine in the efficient heat generation operation is larger than that in the normal operation.

5. The elevator control device according to claim 1, wherein the program diagnoses that an abnormality has occurred in the cooling effect when a time with respect to a temperature rise of the temperature measurement value is out of a normal range.

6. The elevator control device according to claim 5, wherein the program records, as past data, a time at which the temperature measurement value reaches a predetermined temperature during the efficient heat generation operation and determines that an abnormality has occurred in the cooling effect when a difference between the past data and a reaching time of a newly measured temperature measurement value exceeds a normal range.

7. The elevator control device according to claim 1, wherein the program diagnoses that an abnormality has occurred in the cooling effect when the temperature rise of the temperature measurement value with respect to time exceeds that in a normal time.

8. The elevator control device according to claim 7, wherein the program records the temperature measurement values during the efficient heat generation operation as past data and determines that an abnormality has occurred in the cooling effect when a difference between the past data and a newly measured temperature measurement value exceeds a normal range.

9. The elevator control device according to claim 1, wherein, on a basis of a rate of change of a time with respect to a temperature rise or of the temperature rise with respect to time, in the temperature measurement values, the program outputs a signal for requesting an emergency response when the rate of change exceeds a predetermined range.

10. The elevator control device according to claim 9, wherein
the component to be cooled is provided with a cooling fin,
one or more of the temperature sensors are provided, and
the program determines, in a case where it is determined that an abnormality has occurred in the cooling effect, that the cooling fan or the cooling fin is clogged when the rate of change is within the predetermined range, and that the cooling fan has failed when the rate of change is not within the predetermined range.

11. The elevator control device according to claim 10, wherein a single temperature sensor of the temperature sensors is provided.

12. The elevator control device according to claim 1, wherein the program estimates a time at which an abnormality is to occur in the cooling effect on a basis of the temperature measurement values of a past during the efficient heat generation operation.

13. The elevator control device according to claim 1, wherein the program controls the hoisting machine so as to suppress heat generation of the component to be cooled to a temperature lower than a temperature during the normal operation when the program determines that an abnormality has occurred.

14. The elevator control device according to claim 1, wherein the program transmits basic specification information or operation information of an elevator, and diagnosis data based on the temperature measurement values obtained from the temperature sensor during the efficient heat generation operation to an external database connected to a plurality of elevator apparatuses via a communication device.
